(19) United States
(12) Patent Application Publication
(10) Pub. No.: US 2005/0018985 A1
(43) Pub. Date: Jan. 27, 2005

(54) Method for controlling numerical aperture of graded index plastic optical fiber through end rounding treatment thereof

(75) Inventors: Mu Gyeom Kim, Gyeonggi-Do (KR); Jin Taek Hwang, Daejeon-Shi (KR); Jin Sung Choi, Daejeon-Shi (KR); Han Sol Cho, Daejeon-Shi (KR)

Correspondence Address: BURNS DOANE SWECKER & MATHIS L L P, POST OFFICE BOX 1404, ALEXANDRIA, VA, 22313-1404, US

(73) Assignee: SAMSUNG ELECTRONICS CO., LTD., Gyeonggi-Do (KR)

(21) Appl. No.: 10/740,506

(22) Filed: Dec. 22, 2003

(30) Foreign Application Priority Data
Jul. 24, 2003 (KR) 2003-50914

(51) Int. Cl. G02B 6/02; G02B 6/18

(52) U.S. Cl. 385/124

(57) ABSTRACT

A method for controlling a numerical aperture of a graded index plastic optical fiber through end rounding treatment of the GI POF. More particularly, the present invention discloses a method for controlling a numerical aperture of a GI POF by rounding the end of the GI POF into a convex or concave shape. According to the present invention, it is possible to increase an optical coupling efficiency of the GI POF thus reducing the volume of a whole system without using an additional optical system.

### BACKGROUND OF THE INVENTION

This non-provisional application claims priority under 35 U.S.C. § 119(a) from Korean Patent Application No. 2003-50914 filed on Jul. 24, 2003, which is herein incorporated by reference.

### FIELD OF THE INVENTION

The present invention relates to a method for controlling a numerical aperture of a graded index plastic optical fiber (hereinafter, referred to as ‘GI POF’) through end rounding treatment thereof, and more particularly to a method for increasing an optical coupling efficiency between a GI POF and an optical source or photo-detector by rounding the end of the GI POF into a convex or concave shape.

### DESCRIPTION OF THE RELATED ART

In the case of an existing commercialized step index plastic optical fiber (hereinafter referred to as ‘SI POF’), it has a numerical aperture as large as 0.4 to 0.5. The larger a numerical aperture is made, the larger a spatial angle for receiving light to be transmitted becomes, whereby the quantity of light from an optical source entering into an optical fiber is increased thus resulting in a reduction of the input optical loss, and an increase of a transmission distance. Such a large numerical aperture, however, has a problem in that, in a contrary case of emitting the light from the optical fiber, a lens has to be used to vary an optical path of the light in order to allow the light to be concentrated onto a photo-detector. The use of the lens inevitably accompanies an optical system thus resulting in an increase of a spatial volume of the whole system.

Differently from the SI POF, a GI POF can serve as a lens by itself if it is vertically sliced in a preform state, since the GI POF has a tendency that a refractive index thereof varies continuously in a radial direction from the center to the periphery thereof. Therefore, the GI POF has a function of a GRIN (gradient index) lens and can be utilized for various purposes. Further, the SI POF is adapted to increase a signal width of digital signals in proportion to an increase of a transmission distance, thereby disadvantageously causing rapid reduction of transmission capacity, but the GI POF, due to its refractive index variation property as stated above, does not allow such a signal width to vary largely even though the transmission distance increases, thereby achieving high capacity of information transmission. However, there is a disadvantage in that a numerical aperture of GI POF is as small as about 0.2 to 0.3, which is smaller compared with the SI POF. This means that, in order to apply the GI POF, instead of the SI POF, to any existing commercialized systems, an optical system including a lens has to be used.

When optical fibers are applied for FITH (fiber in the home) and home network purposes, a conversion system between optical and electrical signals is required. This system should have a small size because it is mounted inside the home. However, it is limited to reduce the volume of the whole system in view of the above-described problem.

Meanwhile, end treatment techniques of glass optical fibers are well known to those skilled in the art. One of them is a method, developed by the Corning Company, of rounding the end of a glass optical fiber by applying heat or a laser beam thereto. The other one is a method, developed by the Luvantix company, comprising the steps of attaching a coreless fiber to a glass optical fiber, disposing a substance including a UV resin on the end surface of the coreless fiber using a nanoinjector, and hardening it by applying ultraviolet rays.

The method of the Corning Company has several disadvantages in that it can achieve only a convex shaped end of an optical fiber, a curvature radius of the convex shaped end is difficult to be varied due to a small core contained in the optical fiber, and the price of end treatment equipment is very expensive due to the use of heat or a laser. Further, since this method cannot create a concave portion essential for the entrance of light into the optical fiber, an additional optical system is required during entering of light, resulting in an increase of the volume of the whole system.

The method of the Luvantix Company, similarly, can achieve only a convex shaped end of an optical fiber. Further, in the method, a coreless fiber is used thus accompanying an optical system, thereby disadvantageously causing a volume increase problem of the whole system. Furthermore, due to the use of very expensive equipment such as a nanoinjector, this method is insufficiently competitive from an economic standpoint.

In the case of the SI POF, although a method for vertically slicing the end of the SI POF is known in a prior art, a method for controlling a numerical aperture by rounding the end of the SI POF into a convex or concave shape has not been disclosed.

### SUMMARY OF THE INVENTION

Therefore, the present invention has been made in view of the above problems, and it is a feature of the present invention to provide a method for increasing an optical coupling efficiency in a GI POF, having a numerical aperture smaller than that of an SI POF, thus reducing the volume of a whole system without using an additional optical system.

In accordance with the feature of the present invention, there is provided a method for controlling a numerical aperture of a graded index plastic optical fiber comprising rounding an end of the GI POF into a convex or concave round shape.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic sectional view illustrating an end rounding process of POF through heat treatment;

FIG. 2 is a schematic sectional view illustrating an end rounding process of POF through polishing treatment;

FIG. 3 is a simulation view of light traveling through the end rounded POF;

FIG. 4 is a graph illustrating the optical path of light having an incident angle of 24° in the simulation view of FIG. 3;

FIGS. 5a and 5b are pictures illustrating end rounded POFs through heat treatment, prepared in an Example of the present invention; and

FIGS. 6a to 6c are pictures illustrating light emission from the end rounded POFs in an Example of the present invention, and a conventional POF having a flat end.

### DESCRIPTION OF THE PREFERRED EMBODIMENTS OF THE PRESENT INVENTION

Now, the present invention will be described in detail.

The present invention adopts heat or polishing treatments for an end rounding process of a GI POF.

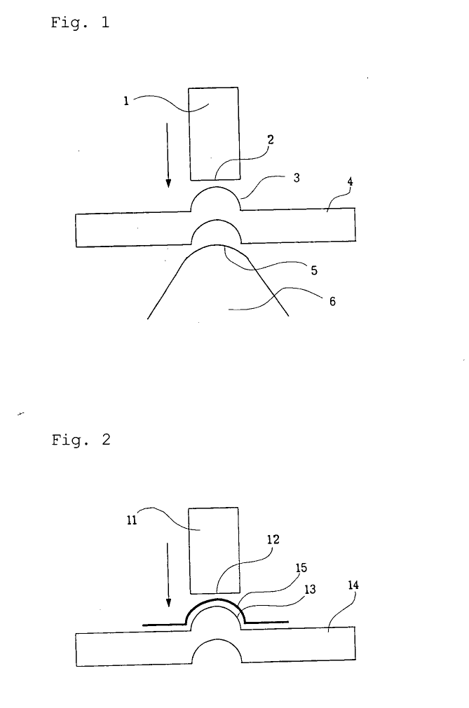

FIG. 1 is a schematic sectional view illustrating the end rounding process of the GI POF through heat treatment.

In order to round an end 2 of the GI POF 1 into a desired concave shape, a substrate 4, having a convex surface portion 3 corresponding to the desired concave shape, should be prepared.

First, a heat transfer means 6 comes into contact at a portion 5 thereof with the substrate 4 so as to heat the substrate 4. After heating of the substrate 4, the end 2 of the GI POF 1 vertically comes into contact with a substantially flat surface portion of the substrate 4 so as to be molten by heat transferred from the substrate 4. Then, the molten end 2 of the GI POF 1 comes into contact with the convex surface portion 3 of the substrate 4 so as to be rounded to achieve the desired concave shape.

Conversely, in order to round the end 2 of the GI POF 1 into a desired convex shape, the same method as stated above is likewise performed, except that the convex surface portion of the substrate is replaced by a concave surface portion.

FIG. 2 is a schematic sectional view illustrating polishing treatment for rounding the end of a GI POF into a desired concave shape.

In order to round an end 12 of GI POF 11 into the desired concave shape, a substrate 14 having a convex surface portion 13 corresponding to the desired concave shape is prepared similarly with the above heat treatment method. A polishing paper 15 is disposed on the convex surface portion 13 of the substrate 14. In a state wherein the end 12 of the GI POF 11 vertically comes into contact with the polishing paper 15, the end 12 of the GI POF 11 is rubbed against the polishing paper 15 as the GI POF 11 rotates, so as to achieve the desired concave shape. Such polishing treatment can be further effectively performed by first using a relatively coarse polishing paper having a particle size of about 12 μm, and then using a fine polishing paper having a particle size of about 1 μm after the polishing treatment has proceeded to some extent.

It may be possible to use polishing powder instead of the polishing paper, but the polishing powder tends to fall from the convex surface portion of the substrate, thereby causing a deterioration of polishing efficiency. Therefore, the polishing powder can be effectively utilized when the substrate is formed with a concave surface portion so as to round the end of the GI POF into a convex shape.

Considering the application of the method according to the present invention to a plastic optical fiber (POF), the end of the POF adapted to receive light from an optical source is rounded into a concave shape, while the end of the POF adapted to emit light therefrom is rounded into a convex shape.

The POF treated according to the method of the present invention has an effect of reducing the volume of a whole system because it is possible to achieve optical coupling between the optical fiber and an optical source or a photo-detector without the assistance of an additional optical system.

Although the method of the present invention is applicable to an existing SI POF system, a numerical aperture is effectively varied in the GI POF than in the SI POF even by low curvature variation due to a refractive index distribution property of a GI POF.

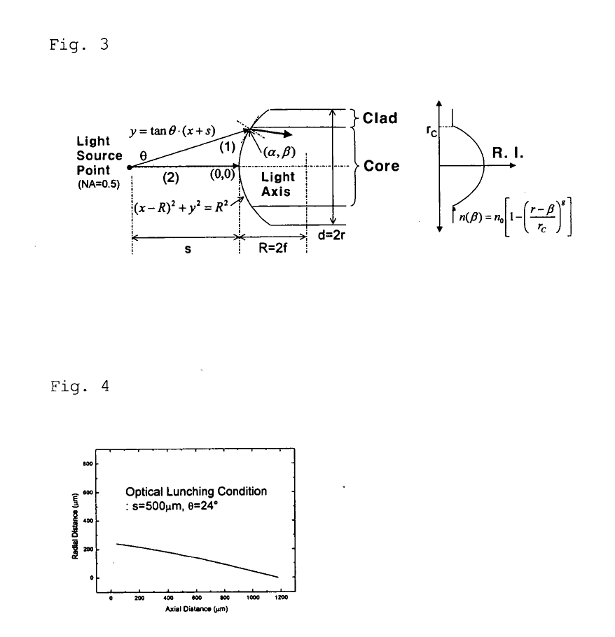

Referring to FIG. 3 illustrating results of a simulated experiment, it can be confirmed that an improvement of transmission performance is obtained by rounding the end of a POF according to the present invention. In FIG. 3, a coordinate (α, β) defines a position that light emitted from an optical source point by an angle θ reaches to the rounded end surface area of the POF. At this position, the light enters the POF by a refractive index value of a refractive index distribution curve shown in the right side of FIG. 3, and an optical path of the entered light varies according to the refractive index distribution curve as the entered light travels in the POF. In this case, if a light emission angle θ from an optical source, a distance s between the optical source and the end of the POF, a refractive index distribution n (β) determined by a core diameter r_{c} of the POF and a variable g, and a curvature radius R of the rounded end of the POF are given, the varied optical path of the light can be calculated by the follow equation:

$$n ( β ) = {n}_{0} [ 1 - {( \frac{r - β}{{r}_{c}} )}^{g} ]$$

FIG. 4 shows an optical path of the light calculated according to the above equation, when the light enters into the POF at an angle of 24° and the POF is distant from an optical source by a distance of 500 μm. Generally, 500 μm is an effective distance for optical coupling between an optical source and a plastic optical fiber. As can be seen from FIG. 4, when the optical path of the light varies from a horizontal path (1) to a slope path (2), a length difference therebetween is only 62 μm, corresponding to a value of 5×10¹² Hz (THz) thus ensuring that it causes no signal distribution problem in a GHz transmission system.

Now, the present invention will be described in detail with reference to an example, but it is provided only for the purpose of explanation without limiting the scope of the present invention.

### EXAMPLE

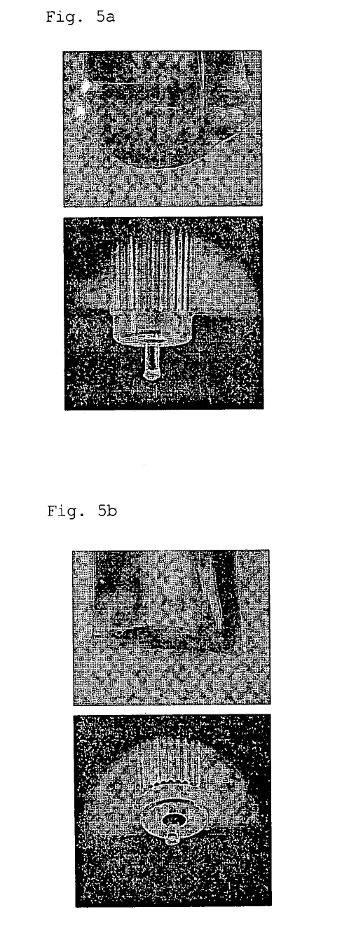

Using the method shown in FIG. 1, ends of POFs having a diameter of 0.75 mm were processed into convex and concave shapes having a curvature radius of 1 mm, respectively. At this time, the used POFs were GI POFs, in which a refractive index difference between a core and a clad thereof is 0.02 and a refractive index distribution variable g is 3.0. The POFs were made of poly(methylmethacrylate) (PMMA) and benzylmethacrylate (BzMA). FIGS. 5a and 5b are pictures illustrating the ends of the POFs processed by the above method.

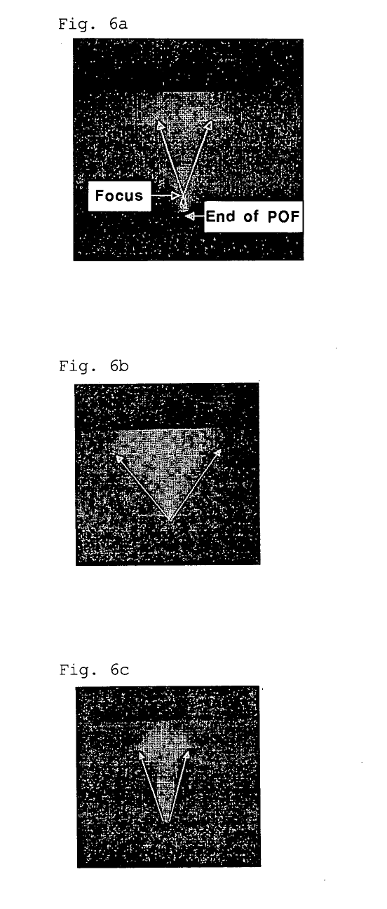

In order to estimate optical performance of the POFs, light having a wavelength of 650 nm was irradiated onto the end of the respective POFs. FIGS. 6a and 6b show spatial distribution of the light emitted from the end of the respective POFs. Meanwhile, FIG. 6c, for the purpose of a comparison, is a picture taken while irradiating the same light onto a conventional POF in which the end thereof is vertically sliced into a flat shape.

In FIG. 6c, the conventional POF having the vertically sliced flat end showed a numerical aperture of 0.287. In case of the POF having the convex end, it could be seen from FIG. 6a that the light emitted from the convex end of the POF is focused in front of the convex end. In case of the POF having the concave end as shown in FIG. 6b, it could be confirmed that a numerical aperture (NA) thereof is essentially doubled up to 0.545, compared with the POF shown in FIG. 6c.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for controlling a numerical aperture of a graded index plastic optical fiber comprising rounding an end of the GI POF into a convex or concave round shape.

2. The method as set forth in claim 1, wherein the end of the GI POF is treated by heat.

3. The method as set forth in claim 1, wherein the end of the GI POF is treated by polishing.

4. The method as set forth in claim 3, wherein the polishing is performed using a polishing paper or polishing powder.
